(19) United States
(12) Patent Application Publication
(10) Pub. No.: US 2025/0244558 A1
(43) Pub. Date: Jul. 31, 2025

(54) CABINET WITH AN INTERIOR SLIDABLE MAGNIFICATION MIRROR

(71) Applicant: Progress Lighting, LLC, Greenville, SC (US)

(72) Inventors: Palmer Joseph Primm, Greenville, SC (US); John Linkoln Dixon, Greer, SC (US)

(21) Appl. No.: 19/039,599

(22) Filed: Jan. 28, 2025

Related U.S. Application Data
(60) Provisional application No. 63/627,017, filed on Jan. 30, 2024.

(51) Int. Cl. G02B 7/182; A47B 67/00; A47B 67/02; A47G 1/00; A47G 1/16

(52) U.S. Cl. CPC G02B 7/182; A47B 67/005; A47B 67/02; A47G 1/1653; A47G 2001/002

(57) ABSTRACT

A cabinet including a cabinet box, at least one door coupled to the cabinet box to form a storage compartment and an accessory system comprising a track and an adjustable mirror, wherein the track is mounted to an inner surface of the at least one door and the adjustable mirror is configured to slidably engage the track.

### CROSS REFERENCE TO RELATED APPLICATIONS

This application claims priority to U.S. Application Ser. No. 63/627,017 filed on Jan. 30, 2024, which is incorporated herein by reference in its entirety.

### BACKGROUND

### Field

The present disclosure relates generally to cabinets and, more particularly, to cabinets with interior slidable magnification mirrors.

### Description of the Related Art

Mirrors are used in many types of situations and environments and come in all shapes, sizes, magnifications, etc. For home use, general purpose mirrors are often provided in which the image is neither magnified (enlarged) or de-magnified (reduced). Such general purpose mirrors are often found in specific areas of a household including, for example, in bedrooms, hallways, rest rooms, etc. While such general purpose mirrors provide a way of obtaining an overall reflection of one's image, they are often insufficient for use for specific purposes including, for example, the application of makeup and other beauty products, which may be applied to the face or hair of the subject.

Vanity, makeup or other magnification type mirrors are often used to aid in the application of beautification products as well as personal grooming of one's skin, hair, etc. Vanity mirrors generally provide a degree of magnification such that the image in the mirror appears larger than it would be in a general purpose mirror.

Vanity mirrors are generally personal mirrors primarily used for grooming, applying makeup, styling hair, etc. They are designed to help an individual look their best and are commonly found in bathrooms, bedrooms, dressing areas, etc. Vanity mirrors can be of various shapes and sizes and may be frameless or may have frames. Vanity mirrors may also come with some type of lighting to provide better reflection and to aid in detailed grooming tasks. In addition to their functional use, vanity mirrors can be attractive and contribute significantly to the aesthetics of a room. Vanity mirrors can be attached to vanity furniture or mounted on the wall. The style and frame of a vanity mirror can be chosen to match the décor of a room.

Users will often utilize multiple types of mirrors to help them perform overall personal grooming. For example, a general-purpose mirror with little or no magnification useful for performing general grooming tasks such as arranging one's hair and overall appearance may be provided. A magnified vanity mirror having a magnification factor useful for applying makeup or performing other tasks requiring a magnified view of the user may also be provided.

It will be appreciated that the space requirements and costs associated with providing multiple types of mirrors for personal use may be excessive. A need exists for mirror assemblies that provide the user with the benefits of multiple types of mirrors having different magnification factors in a convenient and compact form.

### SUMMARY

According to an illustrative implementation of the present disclosure, a cabinet includes a cabinet box, at least one door coupled to the cabinet box to form a storage compartment and an accessory system including a track and an adjustable mirror, wherein the track is mounted to an inner surface of the at least one door and the adjustable mirror is configured to slidably engage the track. The track can be made from a magnetic material. At least a portion of the inner surface of the at least one door can include a magnetic material. The track can be attached to the inner surface of the at least one door utilizing at least one magnet. The accessory system can further include an adjustable articulating assembly mounted between the adjustable mirror and the track. The adjustable articulating assembly can include an arm movably attached to the adjustable mirror and a sliding member slidably engaging the track. An articulating member can movably attach the arm to the adjustable mirror. An articulating member can movably attach the arm to the sliding member. The arm can include at least one of a single section of material and a telescoping member. The track can include at least one of a detent type track including a detent type stop, a friction type track including a friction type stop and a magnetic type track including a magnetic type stop.

According to another illustrative implementation of the present disclosure an adjustable mirror assembly is attachable to a cabinet and includes a track having a movable member configured to slid along the track, an articulating assembly mounted to the movable member and a mirror mounted to the articulating assembly. The mirror can be a magnifying mirror. The mirror can be movable by the articulating assembly between a stowed position and a deployed position. The articulating assembly can include an arm and at least one adjustable member. The at least one adjustable member can include two adjustable members. The arm can include a solid member or a telescoping member. The mirror can be mounted to the telescoping member via the at least one adjustable member. The telescoping member can be mounted to the movable member via the at least one adjustable member. The track can be attachable to a rear surface of a door attached to the cabinet by at least one of screws, adhesives and magnetic force. The track can include at least one of a detent type track including a detent type stop, a friction type track including a friction type stop and a magnetic type track including a magnetic type stop. The magnifying mirror can have a magnification factor of 2×-10× or more.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a front elevation view of a cabinet according to an illustrative implementation of the present disclosure.

FIG. 2 is a front elevation view of the cabinet of FIG. 1 with door open, according to an illustrative implementation of the present disclosure.

FIGS. 3-5 are side perspective view of a portion of the door of the cabinet depicted in FIG. 2, taken along lines 3-5-3-5 according to an illustrative implementation of the present disclosure.

FIG. 6 is a partial side view of the cabinet depicted in FIG. 1 taken along the lines 6-6 according to an illustrative implementation of the present disclosure.

FIG. 7 is an enlarged front perspective view of a portion of a track assembly according to an illustrative implementation of the present disclosure.

FIG. 8 is an enlarged front perspective view of slide member according to an illustrative implementation of the present disclosure.

FIGS. 9A and 9B are enlarged cross-sectional views of the track assembly of FIG. 7 taken along lines 9A,9B-9A,9B according to an illustrative implementation of the present disclosure.

FIG. 10A is an enlarged partial exploded view of an articulating assembly according to an illustrative implementation of the present disclosure.

FIG. 10B is an enlarged perspective view of a portion of an articulating assembly according to an illustrative implementation of the present disclosure.

FIG. 11 is an enlarged front perspective view of a portion of a track assembly according to another illustrative implementation of the present disclosure.

FIG. 12 is an enlarged front perspective view of slide member according to another illustrative implementation of the present disclosure.

FIG. 13 is an enlarged cross-sectional view of the track assembly of FIG. 11 taken along lines 13-13 according to an illustrative implementation of the present disclosure.

FIG. 14 is an enlarged front perspective view of a portion of a track assembly according to another illustrative implementation of the present disclosure.

FIG. 15 is an enlarged cross-sectional view of the track assembly of FIG. 14 taken along lines 15-15 according to an illustrative implementation of the present disclosure.

FIG. 16 is an enlarged front perspective view of a slide member according to another illustrative implementation of the present disclosure.

FIG. 17 is a front elevation view of a cabinet with door open, according to an illustrative implementation of the present disclosure.

FIG. 18A is a top view of an inside of a cabinet door illustrating a portion of a track assembly, according to an illustrative implementation of the present disclosure.

FIG. 18B is an enlarged perspective view of a slide member according to another illustrative implementation of the present disclosure.

FIG. 19 is a front view of an articulating arm assembly according to another illustrative implementation of the present disclosure.

### DETAILED DESCRIPTION

The present disclosure provides implementations of cabinet assemblies that include an adjustable accessory on the interior of a cabinet door. According to an illustrative implementation, the accessory is a magnifying mirror coupled to an interior of a cabinet door such that the magnifying mirror can be positioned in accordance with a user's preference. When the cabinet door is closed the magnifying mirror is out of site. The magnifying mirror can be coupled to the interior of the cabinet door utilizing a track with a stop for maintaining the mirror in set positions. The track can be, for example, a detent type track having a detent type stop, a friction type track having a friction type stop, a magnetic type track having a magnetic type stop just to provide non-limiting illustrative exemplary implementations. Other types of tracks with other types of stops are contemplated by the present disclosure.

While illustrative implementations of the present disclosure can describe cabinet assemblies for use in bathrooms and the like (e.g., medicine cabinets), the concepts disclosed herein can also be employed in cabinets used in other locations and for other purposes. For ease of description only, the following description can refer generally to such cabinets as “medicine cabinets.”

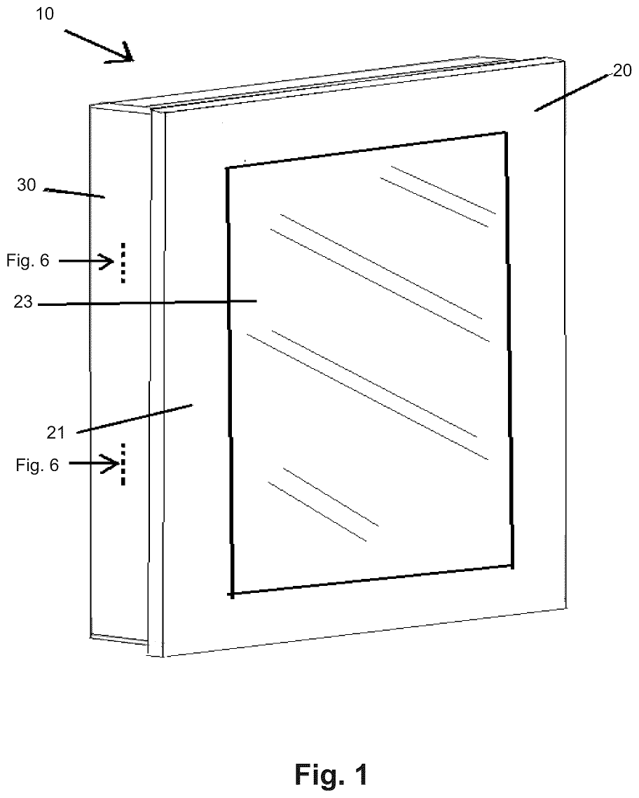

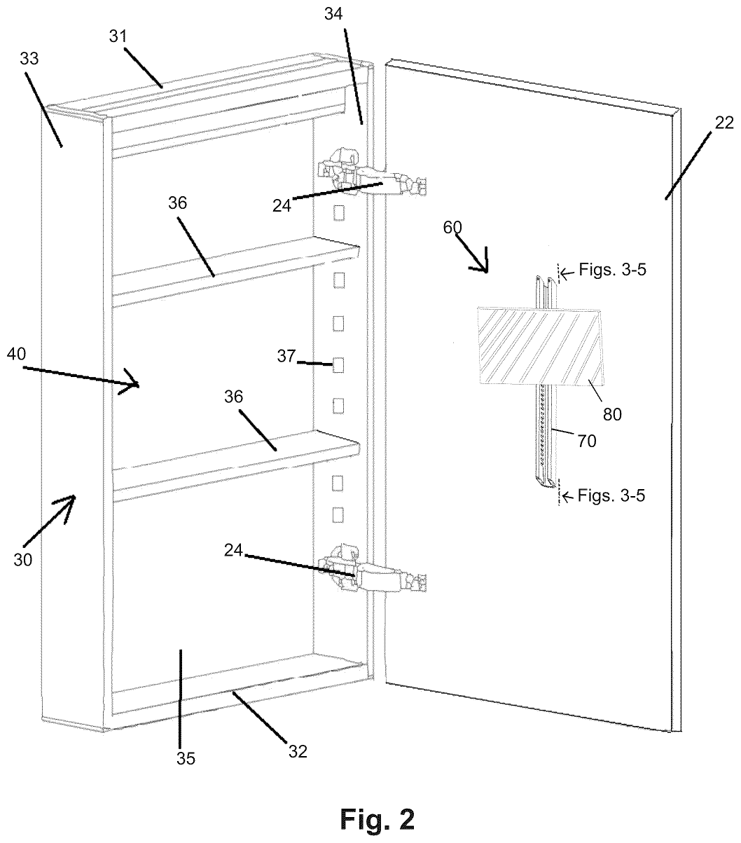

A cabinet according to an illustrative implementation of the present disclosure is shown in FIGS. 1 and 2 and is referred to herein as cabinet 10. Cabinet 10 includes a cabinet box 30, at least one cabinet door 20 coupled to the cabinet box 30, and an accessory system 60 coupled to an interior rear surface 22 of cabinet door 20. Door 20 has an outer or front surface 21 that is exposed when the door 20 is in the closed state. The interior rear surface 22 of cabinet door 20 is only exposed when the door 20 is an in open state. The front surface 21 of door 20 can include a mirror 23 attached to or otherwise forming a portion of the front of door 20. According to an illustrative implementation of the present disclosure, mirror 23 can be a general purpose mirror having little or no magnification. For example, mirror 23 can have conventional mirror properties and includes a face and a reflective layer located on a rear side of the face. The mirror can be made of, for example, glass, plastic, etc. The reflective layer 104 can be made of a highly polished metal, such as silver and aluminum, to reflect light.

Door 20 is pivotably coupled to the cabinet box 30 by one or more hinges 24 that permit the door 20 to open and close relative to the cabinet box 30 in a conventional manner. Two hinges 24 are illustrated, but more or less can be used in alternative implementations. Door 20 is shown in a closed state in FIG. 1 and in an open state in FIG. 2. The cabinet box 30 and the doors 20 collectively form a storage compartment 40. In some implementations, the cabinet 10 can be used as a bathroom cabinet or a medicine cabinet to store items that are typically used in the bathroom, such as a toothbrush, toothpaste, contact lenses, deodorant, medicine, or the like. Of course, other uses for the cabinet are possible and within the scope of the present disclosure.

The cabinet box 30 can be formed from any material that is commonly or conventionally used to manufacture cabinets. For example, the cabinet box 30 can be formed from metal, plastic, wood, or a combination thereof. The cabinet box 30 includes a top panel 31, a bottom panel 32, two side wall panels 33, 34, and a rear panel 35. The rear panel 35 can be the mounting surface for the cabinet 10 and can be configured to couple the cabinet box 30 to a support surface. For example, the cabinet 10 can be configured to be attached to a support surface, such as a wall in a bathroom or other room in a home, using a flush mount or recess mount technique. In a recess mounting, at least a portion of the cabinet box 30 is recessed within the wall while a flange (not shown) at the front of the cabinet box 30 abuts against the surface of the wall. In a flush mounting, the entirety of the cabinet 10 is positioned on an outer surface of the wall and none of the cabinet box 30 is recessed. These are conventional techniques for mounting a cabinet, and particularly a medicine cabinet, to a wall in a home and therefore no further details related to the mounting techniques will be provided herein.

In the exemplary implementation shown, one or more shelves 36 are positioned within the storage compartment 40. The inside surfaces of side wall panels 33, 34 can include one or more attachment points 37 which can be, for example, recesses for receiving holding pins such that shelves 36 can be adjustable so that they can be selectively positioned at varying locations within the storage compartment 40. One or more of the shelves 36 can extend an entire width of the cabinet box 30. Alternatively, one or more of the shelves 36 can extend only a partial width of the cabinet box 30. In this case, cabinet box 30 can include one or more vertical uprights for supporting the free end of the partial width shelf. The shelves 36 can also have a retaining lip (not shown) along a front peripheral edge of the shelf. The retaining lip can extend above an upper surface of the shelf, such that the retaining lip can help prevent objects from falling off of the front of the shelf. Shelves 36 that extend a partial width of the cabinet box 30 can include a retaining lip along the side of the peripheral edge of the shelf. For example, the retaining lip can be extended along the free end of the shelf, (e.g., the end that does not abut a side wall 33, 34). In this way, the retaining lip on the end surface of the shelves can also prevent objects from rolling off an end of the shelf. It should be noted that while one specific configuration of the cabinet 10 is shown in the accompanying figures, other configurations are possible. For example, cabinets having a different number or arrangement of shelves can be provided.

Referring to FIGS. 2-6, an accessory system 60 according to an illustrative implementation of the present disclosure is shown. The accessory system 60 includes a track 70, mirror 80 and an adjustable articulating assembly 68 adjustably attaching mirror 80 to the track 70. Mirror 80 can have little to no magnification or can have a magnification factor of 2×-10× or more. In particular, mirror 80 can have a magnification suitably selected to provide the user with a detailed view of themselves while performing personal grooming tasks including applying facial beautification or other makeup products, hair styling, etc. Track 70 can be attached to the rear surface 22 of door 20 in any suitable manner depending, for example, on the mechanical characteristics of door 20. For example, if door 20 is wood, plastic or other similar material, screws can be used to attach track 70. Alternatively, or in addition, an adhesive can be utilized. If the door 20 and track 70 are formed from or include a magnetic material that is attracted by a magnet, track 70 can be attached to door 20 utilizing one or more magnets (not shown) including, for example, rare earth magnets. As shown in FIGS. 2, 3 and 6, when mirror 80 is in a home or stowed position, the accessory system 60 has a slim profile allowing door 20 to be freely closed. As shown in FIG. 6, cabinet 10 is dimensioned such that when door 20 is in the closed position and mirror 80 is in the stowed position, the distance “E” between the inside of rear wall 35 and the front of mirror 80 can be referred to as the “clearance distance”. This clearance distance “E” extends for at least the distance “F” spanned by track 70. To ensure such a clearance distance is provided, the width “W” of some of the shelves 36 can be such that when installed, they allow a gap “D” between the shelf 36 and the rear surface 22 of door 20. Other shelves (e.g., shelf 36A) which are not within the distance “F” spanned by track 70 can have a larger width and can, for example, span the distance from the inside of rear 35 of cabinet 30 up to the rear surface 22 of door 20 if desired.

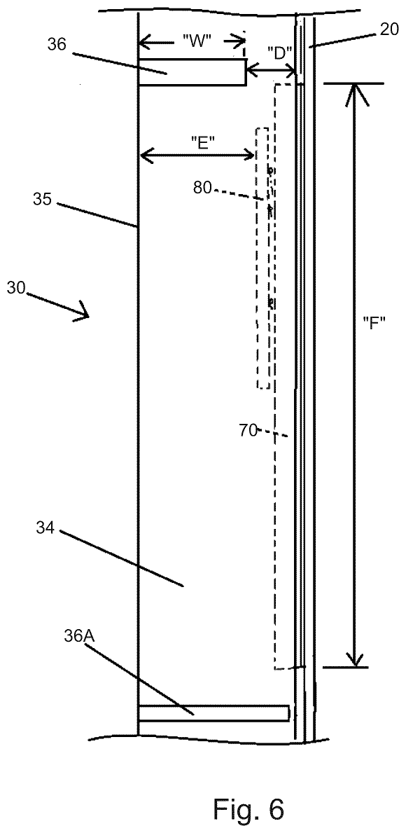

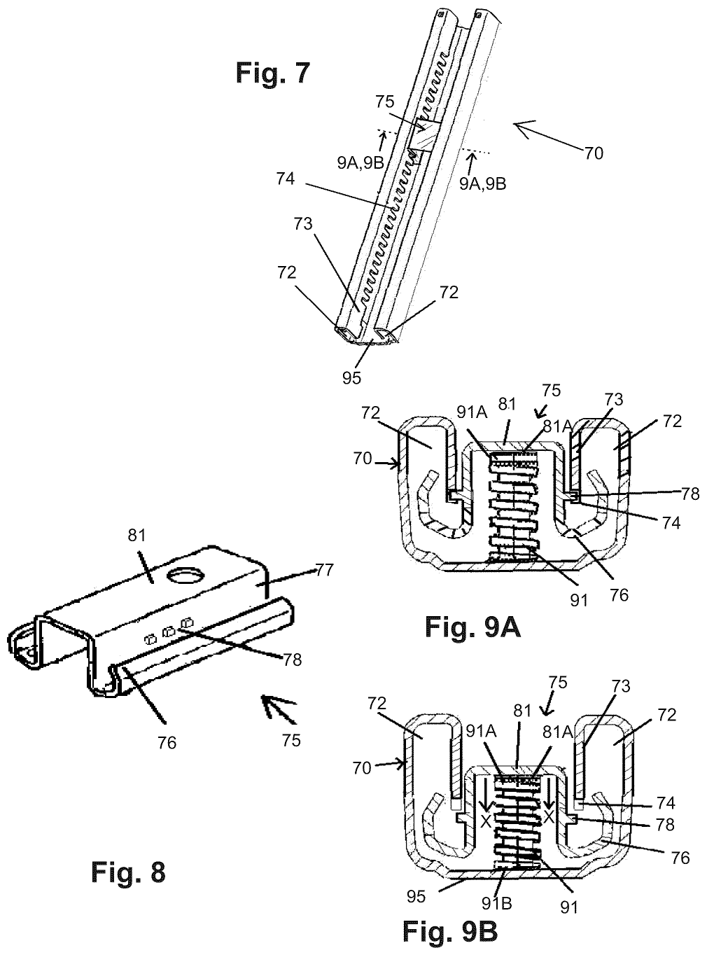

The accessory system 60 according to an illustrative implementation of the present disclosure includes a track 70 as shown in FIG. 7. Track 70 includes a pair of parallel longitudinal U-shaped outside rails 72 interconnected by a base member 95. An inside portion 73 of at least one of the U-shaped outside rails 72 includes a series of notches or detents 74 as shown. Accessory system 60 also includes a slide member 75 which is slidably positioned in track 70 and is depicted in FIG. 8. Slide member 75 includes an upside down U-shaped central body 77 having an upper surface 81. U-shaped central body 77 is dimensioned to ride between the inside portions 73 of track 70. Slide member 75 includes wing portions 76 extending outward which are dimensioned to slidably engage and ride within the U-shaped outside rails 72 of track 70. One or more tabs 78 extend outwardly from one or more of the sides of central body 77. Tabs 78 are positioned and dimensioned to selectively engage the notches or detents 74 provided along the inside portion of the U-shaped outside rails 72.

According to an illustrative implementation of the present disclosure as depicted in FIGS. 9A, 9B, the proximal ends 91A of one or more springs 91 are attached to an underside 81A of the upper surface 81 of central body 77 of slide member 75. Attachment can be by weld, adhesive, screw or any other type of suitable connection. The distal ends 91B of the one or more springs 91 are free to slide along the base member 95 of track 70 when slide member 75 is moved within track 70. The one or more springs 91 bias slide member 75 upward such that the one or more tabs 78 normally engage the notches or detents 74 in track 70 as depicted in FIG. 9A. When slide member 75 is pressed downward in direction “X” against the force of the one or more springs 91, the one or more tabs 78 disengage from the notches or detents 74 in track 70 allowing slide member 75 to be freely slid along track 70. When the downward force is released from slide member 75, slide member 75 is urged upward by the one or more springs 91 so that the one or more tabs 78 again engage the notches or detents 74 in track 70 (FIG. 9A), and maintain slide member 75 in that position.

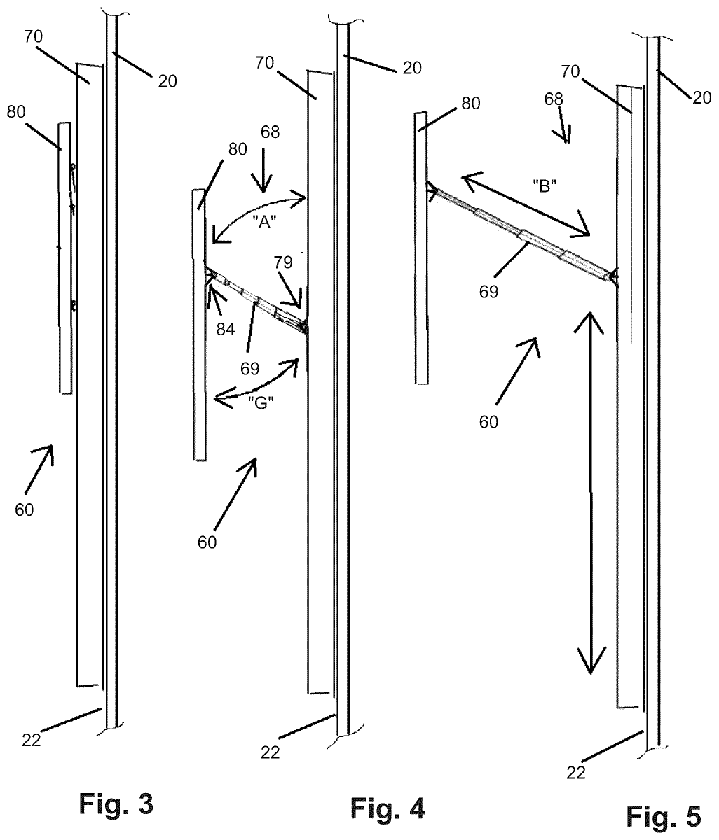

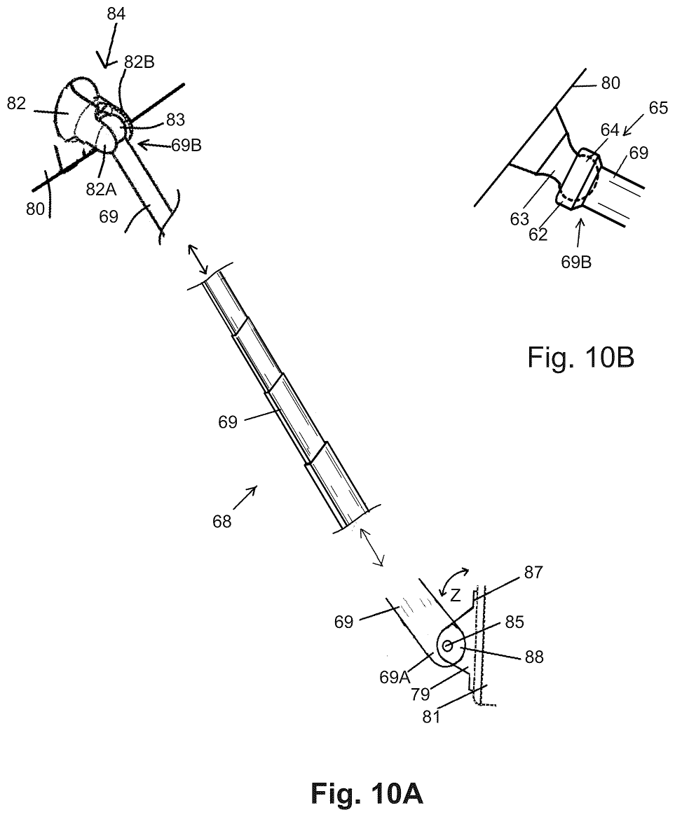

Accessory system 60 also includes an adjustable articulating assembly 68 adjustably attaching mirror 80 to the track 70 and, in particular to slide member 75. According to an illustrative implementation of the present disclosure as depicted in FIG. 10A, adjustable articulating assembly 68 includes adjustable attachment members 84 and 79 interconnected via arm 69. Arm 69 can be a single section of material of a length so that mirror 80 extends a sufficient distance from the rear 22 of door 20 when mirror 80 is moved to the extended position shown in FIG. 4. Generally, such a sufficient distance will provide the user with an easy view for applying beautification or other makeup products and/or for performing other self-grooming tasks. Alternatively, arm 69 can be formed from two or more sections of material joined to form a telescoping member as also shown in FIGS. 1-8. The telescoping member 69 provides the user with a greater degree of versatility and adjustability of the mirror 80. For example, the telescoping member 69 allows the mirror 80 to be adjusted to various heights and allows the mirror 80 to be moved further from the door 20 and closer to the user for an even better view for easier application of makeup products and self-grooming (e.g., see FIG. 5). Telescoping member 69 can be formed from one or more sections of round tubular sections of material as shown in FIGS. 4 and 5 which provides additional versatility of the mirror 80 allowing it to rotate around the longitudinal axis formed by telescoping member 69. Alternatively, as depicted in FIG. 10, telescoping member 69 can be formed from one or more sections of substantially flatter rectangular tubular sections. It will be appreciated that the telescoping member depicted in FIG. 10 would allow the mirror 80 to be positioned closer to the track 70 when in the home position depicted in FIG. 3 than would be possible with a telescoping member having round tubular sections.

According to the present illustrative implementation, adjustable attachment member 84 is a ball-socket type joint which includes a ball 83 extending from a distal end 69B of telescoping member 69. A socket member 82 is attached to a rear surface of mirror 80. The socket member 82 can be attached to the rear surface of mirror 80 utilizing any suitable type of attachment including, for example, adhesive and/or any other suitable type of mechanical fastener. The socket member 82 includes socket arms 82A, 82B which receive the ball 83 and allow socket member 82 (and mirror 80) to be adjusted to and stay in any of a variety of positions. Attachment member 79 includes a base member 87 which is attached to the upper surface 81 of slide member 75. Base member 87 can be attached to the upper surface 81 of slide member 75 by screws, nuts and bolts, adhesive or any other suitable type of connection. Attachment member 79 includes a pair of parallel raised arms 88 (only one of which is shown), each of which includes an orifice 85. The proximal end 69A of telescoping member 69 is fitted between the parallel raised arms 88. The proximal end 69A of telescoping member 69 includes an orifice which is dimensioned and positioned to align with the orifices 85 in parallel raised arms 88. A pin or screw (not shown) can be inserted through orifices 85 to attach telescoping member 69 to attachment member 79. The pin or screw provides an axis of rotation allowing telescoping member 69 to rotate in the directions shown by arrows “Z”. In particular, telescoping member 69 can be rotated to a home position depicted in FIG. 3 such that the telescoping member 69 can be at least partially recessed within track 70.

According to another illustrative implementation of the present disclosure, the rear side of mirror 80 can be pivotably attached to the distal end 69B of telescoping member 69 via attachment member 65, as shown in FIG. 10B. According to the illustrated implementation of the present disclosure depicted in FIG. 10B, attachment member 65 is a ball-socket joint which includes a socket portion 62 attached to distal end 69B of telescoping member 69 and ball portion including ball 64 and base 63 attached to the rear of mirror 80. The base 63 of attachment member 65 can be attached to the rear surface of mirror 80 utilizing any suitable type of attachment including, for example, adhesive and/or any other suitable type of mechanical fastener. The ball-socket joint depicted in FIG. 10B allows mirror 80 to be pivoted and rotated in various directions as desired. It should be noted that in place of the attachment member 79, telescoping member 69 can be attached to slide member 75 utilizing a ball-socket joint similar to ball-socket joints 84 and 65 depicted in FIGS. 10A and 10B providing an even greater degree of adjustability to mirror 80.

As noted above, telescoping member 69 is pivotably attached to slide member 75 thus allowing the telescoping member 69 to be moved up and down track 70. For example, telescoping member 69 can be held by the user and pressed towards track 70 disengaging tabs 78 from detents 74 (e.g., see FIG. 9B). The user can then move telescoping member 69 up and down track 70 a distance “F” (e.g., see FIG. 6), releasing it when in a desired position so that tabs 78 reengage detents 74. Mirror 80 is capable of pivoting outward away from door 20 as shown by arrows “A” in FIG. 4. The length of telescoping member 71 can be extended or retracted by pulling or pushing mirror 80 outwards from or inwards towards track 70 as shown by Arrows “B” in FIG. 5. This allows the mirror 80 to be extended even further from the rear 22 of door 20 and closer to a user as shown in FIG. 5. Mirror 80 is also able to pivot and rotate about ball-socket joint 84 in multiple direction including that indicated by arrows “G” in FIG. 4.

Various types of adjustable mounting systems are contemplated by the present disclosure for movably attaching the magnification mirror 80 to the door 20, besides the detent type track described above. Such adjustable mounting systems can include, for example, friction type track systems, magnetic type track systems etc. Of course, other adjustable mounting systems are contemplated by the present disclosure.

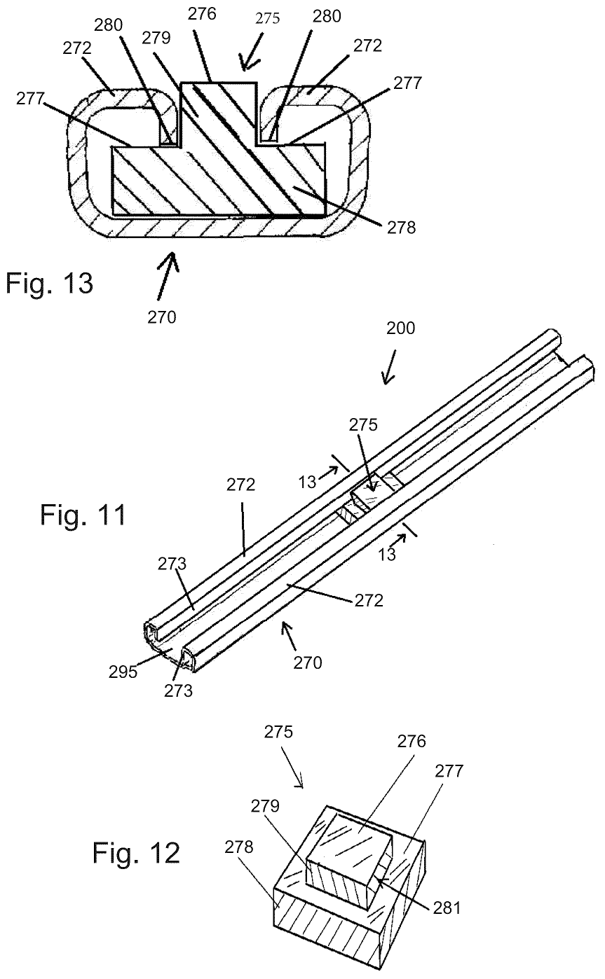

For example, according to another illustrative implementation of the present disclosure a friction type track system such as that depicted in FIGS. 11-13 can be utilized and is referred to as track system 200. Track system 200 has a track 270 which includes a pair of parallel longitudinal U-shaped outside rails 272 interconnected by a base member 295. Track system 200 also includes a slide member 275. As depicted in FIG. 12, slide member 275 includes a lower portion 278 and an upper portion 279. Lower portion 278 of slide member 275 is dimensioned to ride within the longitudinal U-shaped outside rails 272 as depicted in FIG. 13. Upper portion 279 of slide member 275 is dimensioned to ride between the inside portions 273 of track 270. An articulating assembly 68 similar to that described above with respect to FIG. 10A can be attached to the upper surface 276 of slide member 275 utilizing any suitable type of attachment such as, for example, screws, nuts and bolts, adhesive, etc. According to an implementation of the present disclosure, track 270 is formed from a material that can be moved or bent out of its original position and when released, will return to its original position. A nonlimiting example of such a material is spring steel. According to the present implementation, the distal end portions 280 of the parallel longitudinal U-shaped outside rails 272 bear against the upper surface 277 of the lower portion 278 of slide member 275. The dimensions of the upper portion 279 of slide member 275 can be selected such that the inside surfaces of outside rails 72 adjacent the side surfaces 281 of the upper portion 279 of slide member 275 can also bear against each other if desired. The force of the spring steel U-shaped outside rails 272 bearing against the upper surface 277 of slide member 275 is sufficient to maintain slide member 275 in a desired position while allowing the user to freely move the slide member 275 (and articulating assembly 68) along track 270.

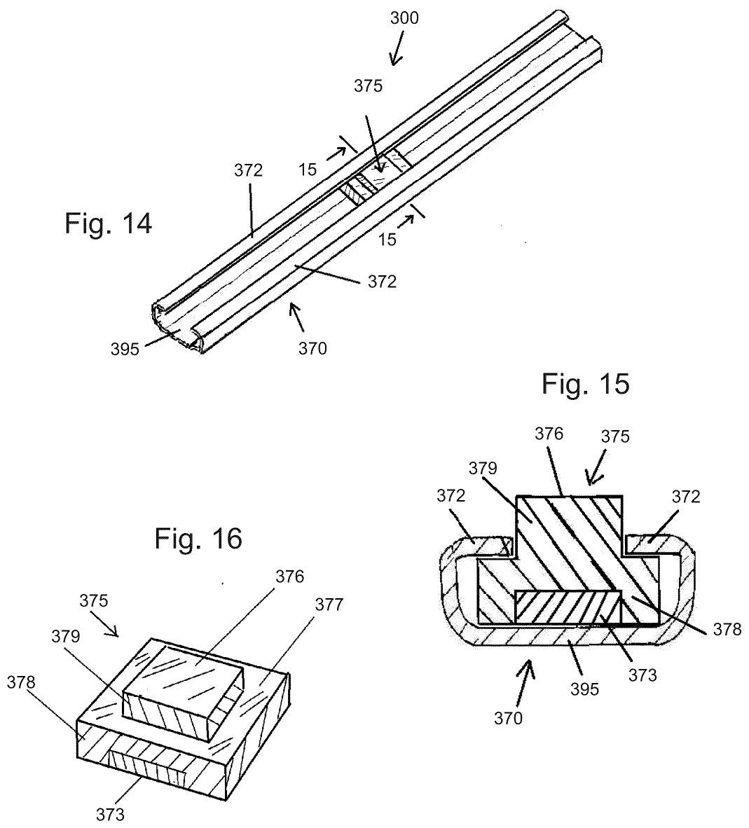

According to another illustrative implementation of the present disclosure a magnetic type track such as that depicted in FIGS. 14-16 can be utilized and is referred to as track system 300. Track system 300 has a track 370 which includes a pair of parallel longitudinal outside rails 372 interconnected by a base member 395 and is formed from a magnetic material readily attracted to a magnet. Track system 300 also includes a slide member 375. As depicted in FIG. 16, slide member 375 includes a lower portion 378 and an upper portion 379. Lower portion 378 of slide member 375 is dimensioned to ride below the longitudinal outside rails 372 as depicted in FIG. 15. Upper portion 379 of slide member 375 is dimensioned to ride between the inside portions of outside rails 372 of track 370 as shown. An articulating assembly 68 similar to that described above with respect to FIG. 10 can be attached to the upper surface 376 of slide member 375 utilizing any suitable type of attachment such as, for example, screws, nuts and bolts, adhesive, etc. According to an implementation of the present disclosure, track 370 is formed from a magnetic material that is readily attracted by a magnet. According to the present illustrative implementation, one or more magnets 373 such as, for example, rare earth magnets are positioned or embedded in the lower portion 378 of slide member 375. Accordingly, slide member 375 is magnetically attracted to track 370 and is readily moved along track 370 by a user and will stay in any desired position along the track 370.

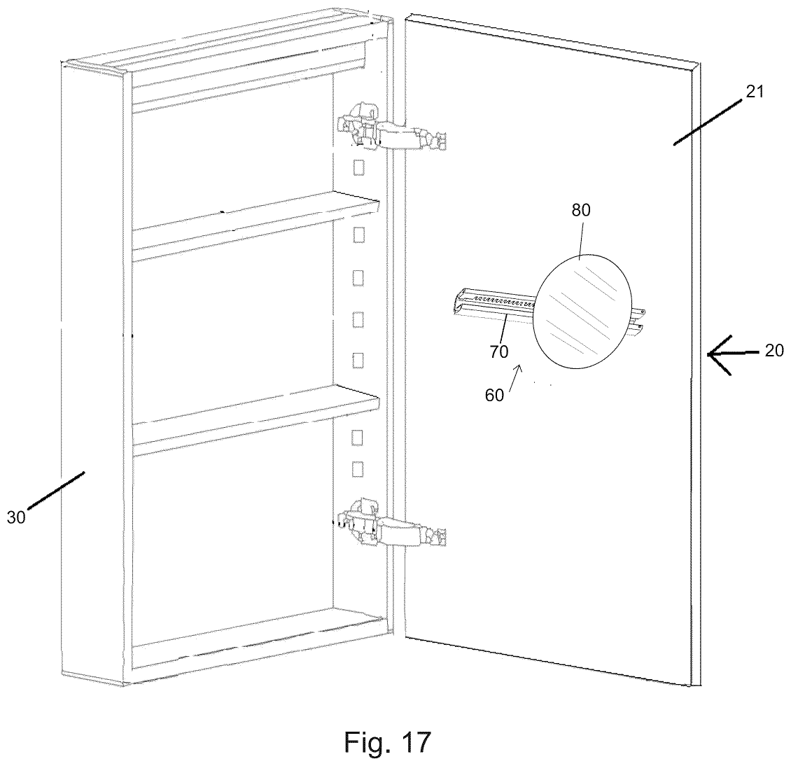

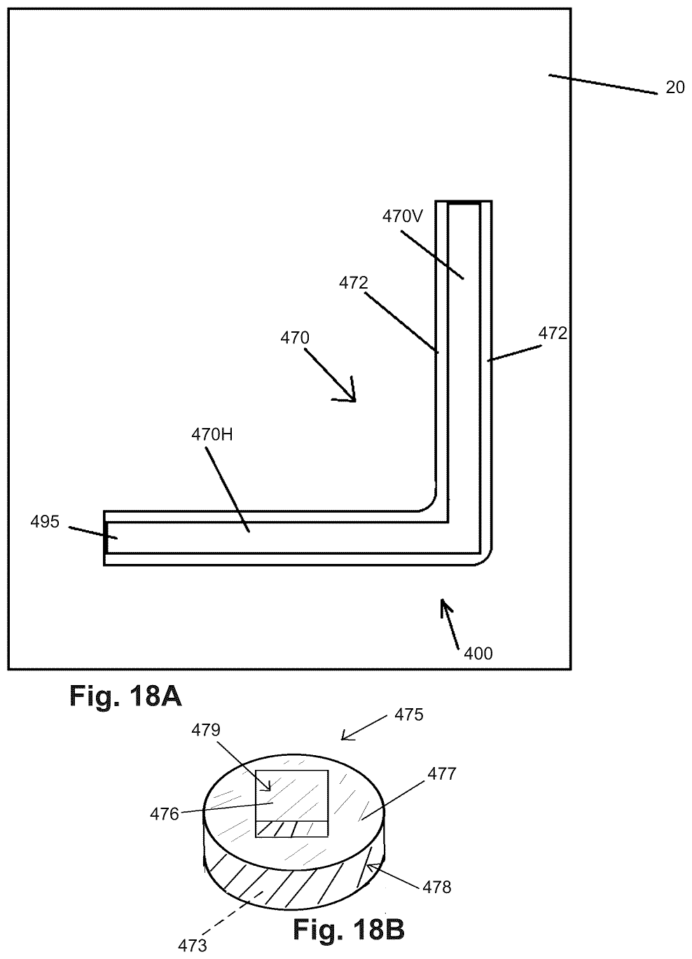

The accessory system 60 can be provided in any suitable configuration. For example, as depicted in FIG. 17, the track (e.g., track 70) can be arranged horizontally across the rear 21 of door 20. The mirror 80 can be any desired shape including, for example, round as shown. Of course, various other mirror shapes can be provided. The tracks described herein can also be provided in various configurations. For example, according to another illustrative implementation of the present disclosure a magnetic type track system such as that depicted in FIGS. 14-16 can be arranged in various configurations. For example, as shown in FIG. 18A, track system 400 includes a track 470 which includes a horizontal track section 470H and a vertical track section 470V. The cross-section of track 470 is similar to the cross-section of track 370 depicted in FIG. 15 and includes rails 472. Track system 400 also includes a slide member 475 as depicted in FIG. 18B. Slide member 475 includes a lower portion 478 and an upper portion 479. Lower portion 478 of slide member 475 is rounded in this implementation and is dimensioned to ride below the longitudinal outside rails 472. Upper portion 479 of slide member 475 is square or rectangular and is dimensioned to ride between the inside portions of outside rails 472. An articulating assembly 68 similar to that described above with respect to FIG. 10 can be attached to the upper surface 476 of slide member 475 utilizing any suitable type of attachment such as, for example, screws, nuts and bolts, adhesive, etc. According to an implementation of the present disclosure, track 470 is formed from a magnetic material that is readily attracted by a magnet. According to the present illustrative implementation, one or more magnets 473 such as, for example, rare earth magnets are positioned or embedded in the lower portion 478 of slide member 475. Accordingly, slide member 475 can be readily moved along track 470 by a user and will stay in any desired position along the track 470. According to the present implementation, the square or rectangular shape of the upper portion 479 of slide member 475 keeps the slide member 475 (and the articulating assembly 68) positioned the same way as the slide member 475 is moved along the along the horizontal track section 470H and the vertical track section 470V. Of course, the upper portion 479 of slide member 475 can be rounded off so that the slide member 475 (and the articulating assembly) is free to rotate if desired.

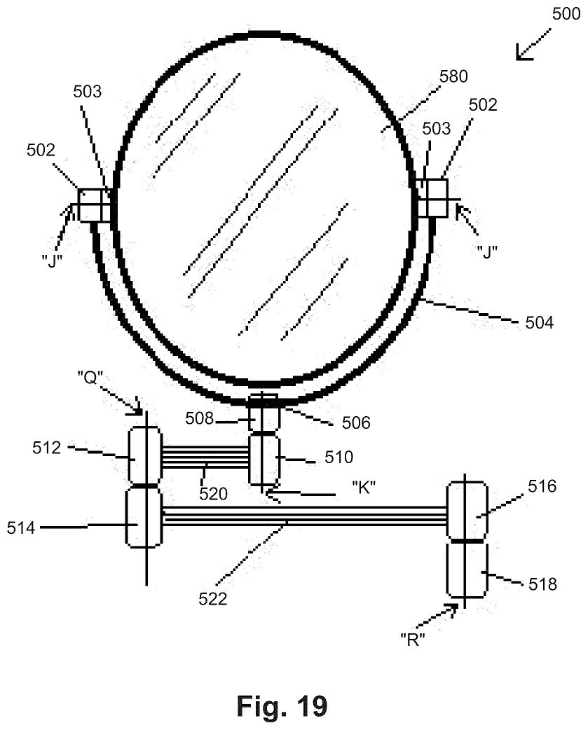

An articulating arm assembly according to another illustrative implementation of the present disclosure is shown in FIG. 19 and is referred to herein as articulating arm assembly 500. Mirror 580 includes arms 503 fixedly mounted to opposite sides of mirror 580. Preferably, mirror is a magnifying mirror having a magnification factor of 2×-10× or more. Arms 503 can be attached directly to mirror 580 utilizing, for example, adhesive. Alternatively, mirror 580 can include a frame (not shown) extending around its outside circumference which can be wood, metal, plastic, etc. In this case, arms 503 can be fixedly mounted to the frame utilizing screws, adhesive and/or other suitable mechanical fasteners. Arms 503 are rotatably attached to arms 502 via pins or screws (not shown) which extend therethrough along axis “J” allowing arms 502 to rotate about axis “J”. Arms 502 are fixedly attached to the distal ends of U-shaped member 504 utilizing suitable types of fasteners including, for example, screws, welds, adhesive, etc. The lower intermediate portion 506 of U-shaped member 504 is rotatably attached to the distal end of arm 508 and arm 510 is rotatably attached to the proximate end of arm 508 in any suitable manner. For example, arms 508, 510 and U-shaped member 504 can be attached via a pin or screw (not shown) which extends therethrough along axis “K” allowing U-shaped member 504 arm 508 and arm 510 to rotate about axis “K”. Extension 520 is fixedly attached to and extends from a side surface of arm 510 and to a side surface of arm 512 as shown. Arm 512 is rotatably attached to arm 514 via pins or screws (not shown) which extend therethrough along axis “Q” allowing arms 512 and 514 to rotate about axis “Q”. Extension 522 is fixedly attached to and extends from a side surface of arm 514. The opposite end of extension 522 is fixedly attached to and extends from a side surface of arm 516. Arm 516 is rotatably attached to arm 518 via pins or screws (not shown) which extend therethrough along axis “R” allowing arms 516 and 518 to rotate about axis “R”. The side surface of arm 518 can be fixedly attached to one of the slide members (75, 275, 375, 475) described above and depicted herein, allowing articulating arm assembly 500 to be movably positioned along the corresponding track. U-shaped member 504 and extensions 520 and 522 can be any suitable type of member capable of adequately supporting the articulating arm assembly 500. Suitable types of members forming U-shaped arm 504 and extensions 502 and 522 can include but are not limited to round bar, square bar and can be hollow or solid. Preferably, the components forming articulating arm assembly 500 can be made from one or more materials which are light in weight. Such materials can include aluminum, tin, copper, plastics, etc. However, other suitable types of materials can be used including stainless steel, etc. The articulating arm assembly 500 thus allows mirror 580 to be adjusted to a myriad of positions.

As shown throughout the drawings, like reference numerals designate like or corresponding parts. While exemplary implementations of the present disclosure have been described herein and shown in the accompanying drawings, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

Certain terminology can be used in the present disclosure for ease of description and understanding. Examples include the following terminology or variations thereof: up, upward, upper, top, inner, outer, down, downward, bottom, lower, etc. These terms refer to directions in the drawings to which reference is being made and not necessarily to any actual configuration of the structure or structures in use and, as such, are not necessarily meant to be limiting.

What is claimed is:

1. A cabinet comprising:
a cabinet box;
at least one door coupled to the cabinet box to form a storage compartment; and
an accessory system comprising a track and an adjustable mirror, wherein the track is mounted to an inner surface of the at least one door and the adjustable mirror is configured to slidably engage the track.

2. The cabinet of claim 1, wherein the track comprises at least one of:
a detent type track comprising a detent type stop;
a friction type track comprising a friction type stop; and
a magnetic type track comprising a magnetic type stop.

3. The cabinet of claim 2, wherein the at least a portion of the inner surface of the at least one door comprises a magnetic material and wherein the track is attached to the inner surface of the at least one door utilizing at least one magnet.

4. The cabinet of claim 1, wherein the accessory system further comprises an adjustable articulating assembly mounted between the adjustable mirror and the track.

5. The cabinet of claim 4, wherein the adjustable articulating assembly comprises an arm movably attached to the adjustable mirror and a sliding member slidably engaging the track.

6. The cabinet of claim 5, further comprising an articulating member movably attaching the arm to the adjustable mirror.

7. The cabinet of claim 6, further comprising an articulating member movably attaching the arm to the sliding member.

8. The cabinet of claim 5, wherein the arm comprises at least one of a single section of material and a telescoping member.

9. An adjustable mirror assembly attachable to a cabinet, the adjustable mirror assembly comprising:
a track comprising a movable member configured to slid along the track;
an articulating assembly mounted to the movable member; and
a mirror mounted to the articulating assembly.

10. The adjustable mirror assembly of claim 9, wherein the mirror comprises a magnifying mirror.

11. The adjustable mirror assembly of claim 9, wherein the mirror is movable by the articulating assembly between a stowed position and a deployed position.

12. The adjustable mirror assembly of claim 9, wherein the articulating assembly comprises an arm and at least one adjustable member.

13. The adjustable mirror assembly of claim 12, wherein the at least one adjustable member comprises two adjustable members.

14. The adjustable mirror assembly of claim 12, wherein the arm comprises a solid member.

15. The adjustable mirror assembly of claim 12, wherein the arm comprises a telescoping member.

16. The adjustable mirror assembly of claim 15, wherein the mirror is mounted to the telescoping member via the at least one adjustable member.

17. The adjustable mirror assembly of claim 16, wherein the telescoping member is mounted to the movable member via the at least one adjustable member.

18. The adjustable mirror assembly of claim 9, wherein the track is attachable to a rear surface of a door attached to the cabinet by at least one of screws, adhesives and magnetic force.

19. The adjustable mirror assembly of claim 9, wherein the track comprises at least one of a detent type track comprising a detent type stop, a friction type track comprising a friction type stop and a magnetic type track comprising a magnetic type stop.

20. The adjustable mirror assembly of claim 10, wherein the magnifying mirror comprises a magnification factor of 2×-10× or more.
